(19) United States
(12) Patent Application Publication
(10) Pub. No.: US 2026/0348350 A1
(43) Pub. Date: Nov. 5, 2026

(54) SYSTEM FOR GENERATING HYDROELECTRIC POWER AND OPERATING METHOD OF SUCH A SYSTEM

(71) Applicants: Guy SARREMEJEANNE, SETE (FR); Aurélie WOESTELAND, POUSSAN (FR); Estelle EMELIE, BAIX (FR); Aude BASSANESE, TAVERNES (FR)

(72) Inventors: Guy SARREMEJEANNE, SETE (FR); Aurélie WOESTELAND, POUSSAN (FR); Estelle EMELIE, BAIX (FR); Aude BASSANESE, TAVERNES (FR)

(21) Appl. No.: 19/119,786

(22) PCT Filed: Aug. 21, 2023
(86) PCT No.: PCT/FR2023/051283

§ 371 Date: Apr. 10, 2025

(30) Foreign Application Priority Data
Oct. 17, 2022 (FR) FR2210695

(51) Int. Cl. F03B 13/06; F04B 9/107

(52) U.S. Cl. CPC F03B 13/06; F04B 9/1073; F05B 2240/241; F05B 2260/422

(57) ABSTRACT

The present disclosure relates to a system for producing hydroelectric power comprising a body divided between a top chamber and a bottom chamber by an intermediate floor, a first water intake duct connected to an outside water source, opening into the top chamber and equipped with a first valve, means for evacuating the water present in the top chamber toward the outside, a piston mounted at an end of a rod traversing the intermediate floor, a sleeve, an upper end of which is attached to the intermediate floor and inside which the rod is able to slide vertically, an annular compression chamber extending the sleeve and terminating at a downstream end by an injection nozzle, a second water intake duct connected to an outside water source, opening into the compression chamber and equipped with a second valve and a check valve, and a hydroelectric turbine supplied with pressurized water through the injection nozzle.

### TECHNICAL FIELD

The present disclosure relates to the general field of the production of hydroelectric power.

It more specifically relates to a system for producing hydroelectric power—also known as a gravitational booster—and its operating method.

### BACKGROUND

Hydroelectric power, or hydroelectricity, is a renewable electric power which comes from the conversion of hydraulic power into electricity. Typically, the kinetic energy of the water current, natural or generated by a difference in level, is transformed into mechanical power by a hydraulic turbine, then into electrical power by a synchronous electric generator.

Thus, the hydroelectric power coming from a dam is based on the height of a water column which supplies to a turbine, placed downstream, a potential energy proportional to this height, the so-called pressure head. In the case of a so-called “run-of-river” device, it is mainly the kinetic energy provided by the flow of the water current (for example a river) which provides the power needed to drive the rotation of one or more turbines. In this precise case, the potential energy, given the slight declivity of the watercourse, only makes it possible to provide the flow.

The known systems for producing hydroelectric power coming from a dam have many drawbacks, particularly of an ecological nature. The effects of a dam with impoundment on the ecosystem are numerous: disappearance of plant and animal populations in the submerged areas, modification of the quality of the river water and therefore of aquatic populations in the impoundments, disruption of river continuity for both sediments and fauna, modification of the hydrology, production of greenhouse gases due to the degradation of the submerged vegetation, modification of the local climate causing a displacement of populations and a modification of their means of subsistence, hazards to aquatic fauna and in particular on fishways, etc.

More precisely, a dam accumulates sediments in the impoundment and filters according to the sediment's granulometry. The coarse sediments form an aggradation in the upper parts of the impoundment which can propagate further upstream in a sediment vortex. The elevation of the riverbed can then aggravate flooding conditions on the river banks. According to the type of catchment, the sediments are liable to trap the contaminants present in the water and may be rich in organic matter.

Whether it be during operations of draining or cleaning, the environmental impact is the result of the degradation of the physico-chemical quality of the water related to the suspension of silt. Suspended matter may be a cause of mortality in fish species by clogging the gills of fish. In addition, silt-type sediments from the bottom of the impoundment constitute anoxic, and therefore reducing, media. The suspension of silt can therefore be associated with the release of contaminants and oxygen-consuming substances. The degradation of water quality is also a result of the release of nitrogen-rich materials in reduced form, particularly ammonia, which is toxic at low concentrations and, when it oxidizes into nitrites and then into nitrates, will contribute to the dissolved oxygen deficit. Finally, the fine sediments discharged into a watercourse clogs the riverbed and thus making it unfit for fish to reproduce.

In addition, hydraulic development alters the hydrology and stops all or part of the sediment inflow coming from upstream. On a natural river, there is an equilibrium between the hydrology of the watercourse, the sediment flow rate and the morphological features of the bed: gradient, width, nature of the bed. The modification of the equilibrium manifests as a reaction of the riverbed morphology to adapt to these new conditions. The effects of this modification are a deficit of erosion materials and a deficit in the transportation capacity.

Moreover, the lowering of the riverbed by erosion can cause disorders for structures downstream: excessively high water intake, lifting of the foundations of bridges, etc. The lowering of the riverbed can traverse the entire alluvial layer and reach the bedrock: the nature of the river floor and the morphology of the riverbed are then completely transformed. The lowering of the watercourse causes the lowering of the floodplain water table, disrupting extraction from the water table and vegetation, which evolves toward drier forms. Clogging of the substrates is particularly harmful in salmon rivers where it leads to a reduction in the development of benthic microfauna which serves as food for the fish. It also limits surfaces favorable to spawn, which require well-oxygenated gravel river floors.

The impact of the disruption of sediment transport by dams appears especially severe since it generally comes in addition to the impacts of other man-made operations. Virtually all human operations on watercourses contribute in the same way to a reduction in sediment inflow available for the mobility of the riverbed; extraction of gravel, dykes, land occupation in the catchments such as agricultural retreat or mountain land restoration which dry up the source of the materials.

In a contaminated area, microparticles of contaminants are conveyed from the source by runoff and watercourses. They spread throughout the aquatic environment, including reservoirs, lakes, groundwater and oceans. In aquatic ecosystems, they are present in all compartments: they are dissolved in the water column, adsorbed into sediments and accumulated in living organisms. These three compartments exchange particles until an equilibrium is reached. Thus, according to the chemical conditions, the deposited sediments and suspended matter may either trap the contaminant present in the water column by adsorption, or release it be desorption.

Dam impoundments accumulate inflowing contaminants in two ways: firstly, the sediment surface deposited on the floor of the impoundment absorbs the contaminant present in the water and, secondly, the contaminated suspended matter will be deposited and stored in the impoundment. But the contaminated sediments of the impoundments may also become a source of contamination a) in the event of a change in the quality of the inflowing river water, which can cause the deposited sediments to release the contaminants and b) in the event of erosion of the sediments of the impoundment in which the contaminated materials, then returned to the suspended state, will release a part of the contaminant into the water to be transported downstream.

The creation of reservoirs and their associated water networks has an impact on the main endemic parasitic diseases. In hot and humid regions, certain of these endemic diseases, which are serious due to their chronic nature and the number of people they affect, are caused by pathogens, the vector hosts of which live in freshwater. These diseases existed in the endemic state before the creation of a dam, but the latter has the effect of greatly increasing possible sites for vectors and, consequently, promoting their propagation. These main diseases are: malaria, schistosomiasis and onchocerciasis.

### SUMMARY

The present disclosure thus has the aim of making provision for a system for producing hydroelectric power which does not have the aforementioned drawbacks.

In accordance with the present disclosure, this aim is achieved owing to a system for producing hydroelectric power comprising at least one power-producing module comprising:
a cylindrical body divided along its height between a top chamber and a bottom chamber by an intermediate floor;
at least a first water intake duct intended to be connected to an outside water source, opening into the top chamber and equipped with a first valve;
means for evacuating the water present in the top chamber toward the outside;
a piston which is mounted at an upper end of a rod traversing the intermediate floor and which is able to vertically slide inside the top chamber;
a sleeve, an upper end of which is attached to the intermediate floor and inside which the rod is able to slide vertically;
an annular compression chamber extending the sleeve at the lower end of which it is attached, the compression chamber terminating at a downstream end by an injection nozzle;
at least a second water intake duct intended to be connected to an outside water source, opening into the compression chamber at a bottom end thereof and equipped with a second valve and a check valve; and
a hydroelectric turbine supplied with pressurized water through the injection nozzle of the compression chamber.

The system according to the present disclosure is noteworthy in that it makes it possible to convert the kinetic energy of a watercourse into potential energy on the basis of the application of Archimedes' principle to floating bodies (as opposed to conventional “run-of-river” hydroelectric production systems which only use the kinetic energy to produce electricity. Specifically, the kinetic energy of flow of the watercourse here plays only a passive role and in no way determines the power provided to the hydroelectric turbine. The flow of the watercourse only allows the filling of the top chamber in which a floating body (i.e. the piston) will rise under the effect of the Archimedes pressure and finally redescend once this volume of water has been flushed from the top chamber.

More precisely, the piston slides in the compression chamber containing a volume of water which will be evacuated at its end toward the hydroelectric turbine, to allow its rotation. The pressure provided by the piston to the volume of water is equivalent to that contributed by a water column over a submerged surface according to the fundamental principle of hydrostatics. The equivalent potential energy contributed by the system according to the present disclosure varies as a function of the mass of the piston and the section of the compression chamber.

Moreover, the system according to the present disclosure has the peculiarity, given the reduction in the water column height, of using only small impoundment heights to produce the power equivalent to that of a dam. This height is for example in the order of 10 to 15 meters or, for a declivity of 2% of a watercourse of 10 km in length, the possible insertion along this riverbed of a production system every 500 to 750 meters, i.e. 13 to 20 production systems.

Another peculiarity of the system according to the present disclosure lies in the separation of the water circuit for hydroelectric production from the water circuit driving the piston. Specifically, the system allows aquatic fauna to migrate downstream without any risk of mortality due to its passage through the turbine blades owing to the means for evacuating the water present in the top chamber or the bottom chamber toward the outside.

Hence, the system according to the present disclosure makes it possible to ensure the protection of ecosystems and to limit the impacts on them which, in the case of impoundments required for the operation of a dam, imperil the aquatic fauna, the climate at a local level and more generally generate greenhouse gases.

According to an embodiment, the intermediate floor comprises at least one closable discharge valve able to put the top chamber in communication with the bottom chamber when it is in the open position, and the cylindrical body of the module comprises at least one hatch opening into the bottom chamber and opening toward the outside, the closable discharge valve and the hatch making it possible to evacuate the water present in the top chamber toward the outside.

In this embodiment, the bottom chamber of the cylindrical body of the module can advantageously contain a floor which is inclined toward the hatch to facilitate the evacuation of the water.

According to another embodiment, the cylindrical body comprises at least one closable gate opening in the bottom part of the top chamber and opening directly onto the outside to evacuate the water present in the top chamber toward the outside.

Preferably, the module further comprises means for damping the piston during its vertical descent in the top chamber.

Also preferably, the module further comprises means for damping the lateral guiding of the piston during its displacement in the top chamber.

The rod of the module advantageously opens at an upper end by way of a pressure-balancing valve so as to promote the intake of air and the filling of the compression chamber during the rise of the piston.

Still preferably, the system comprises two power-producing modules intended to operate by turns and supplying pressurized water to the same hydroelectric turbine.

Another subject of the present disclosure is a method for operating the system for producing hydroelectric power as previously defined, successively comprising for each module:
the closing of the means for evacuating the water present in the top chamber toward the outside;
the opening of the first valve and of the second valve to respectively fill the top chamber and the compression chamber with water, the filling of the top chamber causing a displacement of the piston toward the top of the cylindrical body; and
once the top chamber has entirely filled with water, the closing of the first valve and of the second valve, followed by the opening of the means for evacuating the water present in the top chamber toward the outside, the draining of the top chamber causing a downward displacement of the piston and of its rod, the downward displacement of the rod exerting a strong pressure on the water contained in the compression chamber which is evacuated through the injection nozzle in order to supply pressurized water to the hydroelectric turbine.

### BRIEF DESCRIPTION OF THE DRAWINGS

FIG. 1 is a perspective view of a system for producing hydroelectric power according to an embodiment of the present disclosure.

FIG. 2 is a schematic and section view of the system of FIG. 1 in its initial phase.

FIG. 3 is a view of the system of FIG. 1 in its start-of-filling.

FIG. 4A-4B FIGS. 4A-4B are views of the system of FIG. 1, in its end-of-filling and cessation-of-filling phase respectively.

FIG. 5A-5B FIGS. 5A-5B are views of the system of FIG. 1, in its start-and end-of-draining phase respectively.

FIG. 6 is a perspective view of a system according to another embodiment of the present disclosure.

FIG. 7 is a perspective system view of a system according to yet another embodiment of the present disclosure.

### DETAILED DESCRIPTION

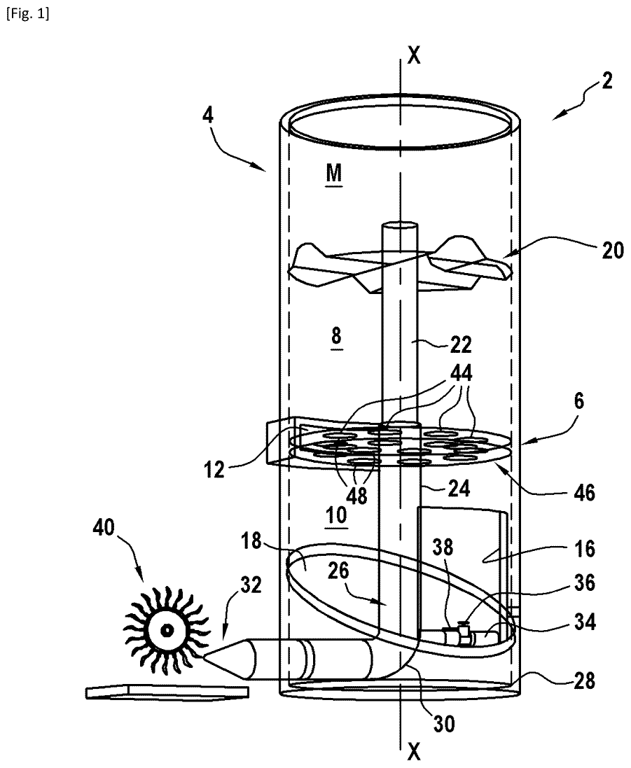

FIG. 1 shows in perspective a system for producing hydroelectric power 2 according to a first embodiment of the present disclosure.

The system 2 is composed of one or more power-producing modules M, each module comprising a cylindrical body 4, the longitudinal axis X-X of which is positioned vertically. This cylindrical body 4 is divided along its height by an intermediate floor 6 between a top chamber 8 and a bottom chamber 10.

The system 2 also comprises one (or more) first water intake ducts 12 opening into the bottom part of the top chamber. This first water intake duct 12 is intended to be connected to an outside water source, typically to the bed of a river, by way of a first valve 14. The water intake duct 12 is dimensioned to allow a rapid filling of the top chamber.

The cylindrical body 4 of the module also comprises at least one hatch 16 which opens into the bottom chamber 10 and which opens onto the outside in order to make it possible to evacuate the water present in the top chamber toward the outside.

The bottom chamber 10 contains a floor 18 which is inclined toward the hatch 16 so as to facilitate the evacuation of the water toward the outside.

The cylindrical body 4 of the module further comprises a piston 20 which is mounted at an upper end of a rod 22 centered on the longitudinal axis X-X and traversing the intermediate floor 6. This piston 20 is able to slide vertically from bottom to top inside the top chamber 8.

More precisely, the rod 22 slides vertically inside a sleeve 24, the upper end of which is attached to the intermediate floor 6.

An annular compression chamber 26 extends the sleeve from the lower end thereof at which it is attached. This compression chamber 26 extends along the longitudinal axis X-X to the bottom 28 of the cylindrical body to extend as a bend 30 which terminates at a downstream end by an injection nozzle 32.

At least a second water intake duct 34 opens into the compression chamber 26 at a bottom end thereof. This second water intake duct 34 is intended to be connected to an outside water source, typically to the bed of a river, by way of a second valve 36. it is moreover equipped with a check valve 38.

The system 2 according to the present disclosure also comprises a hydroelectric turbine 40 which is supplied with pressurized water via the injection nozzle 32 of the compression chamber 26. This hydroelectric turbine 40 is for example a turbine of Pelton, Kaplan, Francis, or other type.

In addition, the rod 22 opens at an upper end by way of a pressure-balancing valve 42 so as to promote the intake of air and the filling of the compression chamber 26 during the rise of the piston 20.

In this first embodiment, the intermediate floor 6 comprises a plurality of closable discharge valves 44 which can put the top chamber 8 in communication with the bottom chamber 10 when these valves are in the open position (and to prevent any communication between the top and bottom chambers when they are in the closed position).

More precisely, these discharge valves 44 here take the form of circular cutouts made in the intermediate floor which are regularly distributed around the longitudinal axis X-X. These circular cutouts are dimensioned to allow the passage of fish present in the river.

To close them off, a circular plate 46 positioned below the intermediate floor and equipped with the same circular cutouts 48 can pivot about the longitudinal axis between an angular position in which the respective cutouts of the intermediate floor and of the plate 46 are aligned (this position corresponds to the open position of the discharge valves 44), and an angular position in which the plate 46 then closes off the cutouts made in the intermediate floor (this position corresponds to the closed position of the discharge valves).

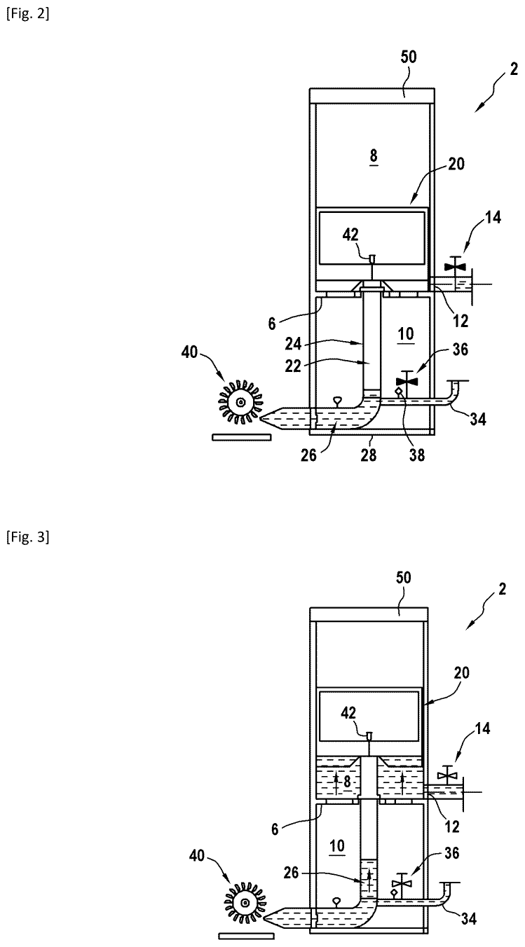

In relation to FIGS. 2, 3, 4A, 4B, 5A and 5B, a description will now follow of a method for operating the system for producing hydroelectric power according to this first embodiment.

FIG. 2 shows the system 2 in its initial phase, i.e. the first valve 14 and the second valve 36 are closed and the piston 20 is in its bottom position.

The valves 14 and 36 are then open to allow the water coming from the river upstream (not shown) to fill both the compression chamber 26 and the top chamber 8 via their respective bottom ends. This is the start-of-filling phase shown on FIG. 3.

During this filling, the piston 20 rises back up toward the ceiling 50 of the body 4 of the system and the rod 22 slides inside the sleeve 24. The pressure balancing valve 42 allows the intake of air following the depressurization which is created inside the sleeve so as to promote the filling of the compression chamber 26 and the rise of the piston.

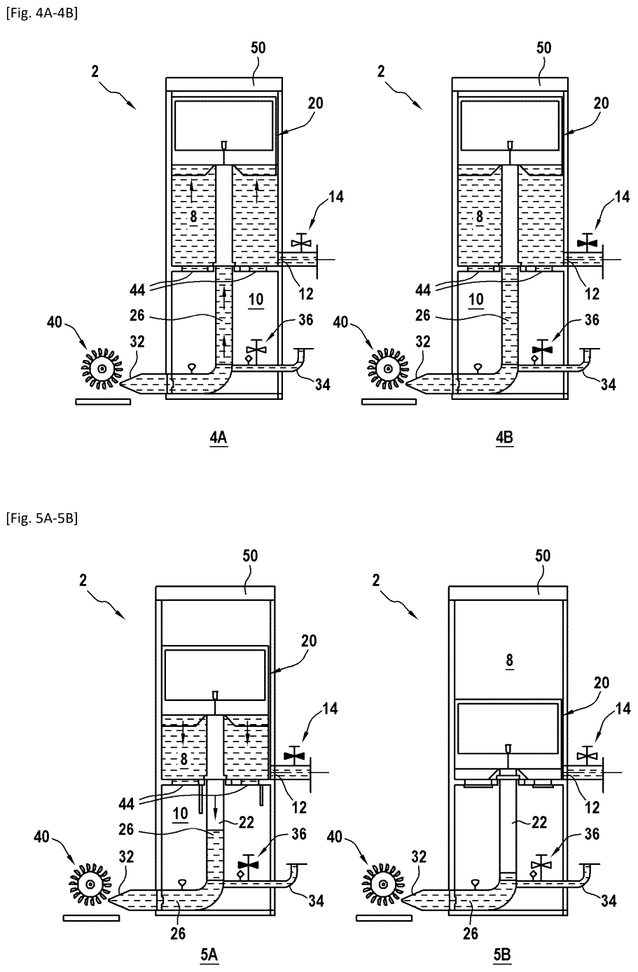

FIG. 4A shows the system in its end-of-filling phase. In this phase, the piston 20 has reached the level of the ceiling 50 of the body 4 and the sleeve 24 is entirely submerged (the compression chamber 26 is entirely filled with water). The first valve 14 and the second valve 36 can then be closed (FIG. 4B).

As shown on FIG. 5A, the drainage phase then begins by opening the discharge valves 44 (here by pivoting the circular plate 46 positioned below the intermediate floor 6). The water (and any fish) present in the top chamber of the body 4 drains into the bottom chamber 10, then toward the outside of the system by passing through the hatch 16.

This flushing system allows the virtually instantaneous emptying of the water present in the top chamber. During this emptying, the piston 20 descends under the effect of its own weight and compresses the water present in the compression chamber 26. The pressurized water is then evacuated through the injection nozzle 32 to supply the hydroelectric turbine 40.

Once the water has been completely flushed from the system and from the compression chamber (FIG. 5B), a new cycle can begin again.

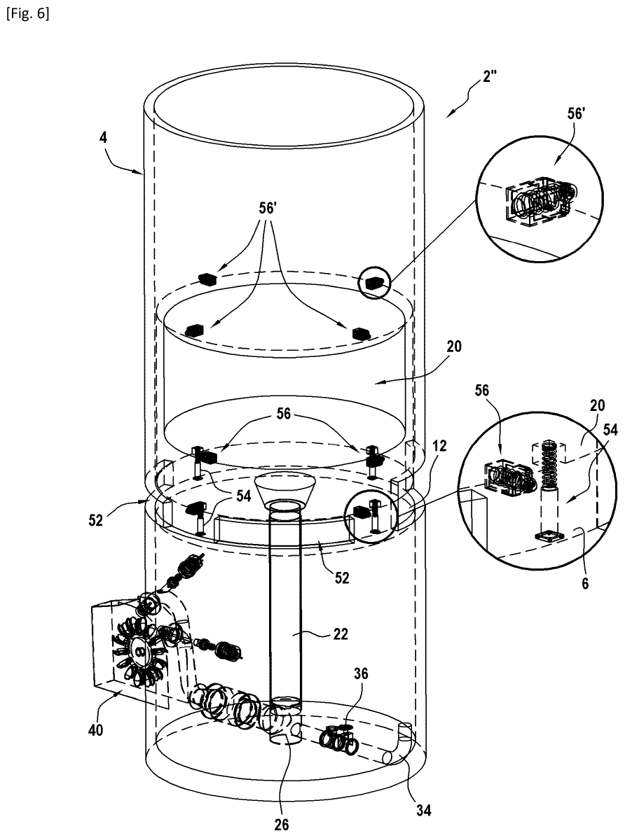

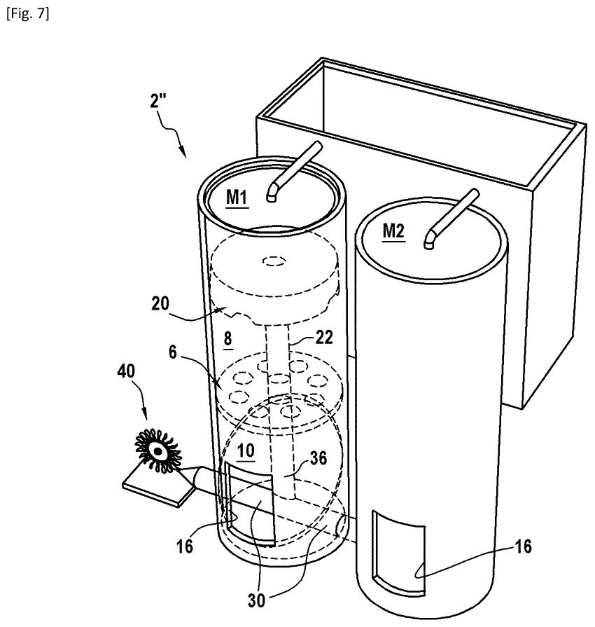

FIG. 6 shows in perspective a module of a system 2′ according to a second embodiment of the present disclosure (the system preferably comprising two identical modules operating one after the other).

The module of this second embodiment is here distinguished from the first in that the cylindrical body 4 comprises at least one closable gate 52 which opens in the bottom part of the top chamber 8 of the body 4 and which opens directly onto the outside in order to evacuate the water present in the top chamber toward the outside.

In other words, in this second embodiment, the water that has just filled the top chamber is drained directly toward the outside of the system without travelling through the bottom chamber (the draining is thus faster). The bottom chamber is devoid of any hatch and inclined floor.

Note that the closable gate 52 is dimensioned to allow the passage of any fish coming from the river that might have been introduced into the top chamber of the system.

Moreover, the device (not shown on FIG. 6) for closing off the gate 52 may for example be a knife gate valve (or any other equivalent device).

With regard to the first embodiment, the system can be more compact (less bulky along its height), due to the fact that the water does not travel through the bottom chamber.

Whatever the embodiment, the system may further comprise means for damping the piston 20 during its vertical descent in the top chamber 8.

For example, as shown on FIG. 6, these damping means may take the form of a plurality of axial spring dampers 54 mounted on the outer periphery of the intermediate floor 6, regularly distributed around the longitudinal axis X-X and bearing against the lower surface of the piston 20.

In addition, and still whatever the embodiment, the system may comprise means for damping the lateral guiding of the piston 20 during its displacement in the top chamber 8.

In the exemplary embodiment of FIG. 6, these damping means take the form of radial spring dampers 56 extending radially and interacting with the axial spring dampers 54 at the lower end of the piston. Other radial spring dampers 56′ can be mounted at the upper end of the piston.

Whatever the embodiment, the system may comprise two power-producing modules as described previously intended to operate by turns and supplying pressurized water to the same hydroelectric turbine.

Thus, in the embodiment of FIG. 7, the system 2″ comprises two power-producing modules M1, M2 similar to that described in relation to FIG. 1 (i.e. with means for evacuating the water present in the top chamber toward the outside which take the form of discharge valves made in the intermediate floor and the hatch made in the bottom chamber of the module M1, M2).

In this embodiment, the respective compression chambers 26 of the two modules M1, M2 share the same bend 30 and open onto a hydroelectric turbine 40 which is shared.

In this embodiment, the power-producing modules M1, M2 operate one after the other, i.e. one of the modules follows the operating method described previously and as soon as the draining is finished, the other module begins its filling in such a way that the shared hydroelectric turbine does not stop operating.

1. A system for producing hydroelectric power comprising at least one power-producing module comprising:
a cylindrical body divided along its height between a top chamber and a bottom chamber by an intermediate floor;
at least a first water intake duct intended to be connected to an outside water source, opening into the top chamber and equipped with a first valve;
means for evacuating the water present in the top chamber toward the outside;
a piston which is mounted at an upper end of a rod traversing the intermediate floor and which is able to vertically slide inside the top chamber;
a sleeve, an upper end of which is attached to the intermediate floor and inside which the rod is able to slide vertically;
an annular compression chamber extending the sleeve at the lower end of which it is attached, the compression chamber terminating at a downstream end by an injection nozzle;
at least a second water intake duct intended to be connected to an outside water source, opening into the compression chamber at a bottom end thereof and equipped with a second valve and a check valve; and
a hydroelectric turbine supplied with pressurized water through the injection nozzle of the compression chamber.

2. The system of claim 1, wherein the intermediate floor comprises at least one closable discharge valve able to put the top chamber in communication with the bottom chamber when it is in the open position, and the cylindrical body of the module comprises at least one hatch opening into the bottom chamber and opening toward the outside, the closable discharge valve and the hatch making it possible to evacuate the water present in the top chamber toward the outside.

3. The system of claim 2, wherein the bottom chamber of the body of the module contains a floor which is inclined toward the hatch so as to facilitate the evacuation of the water.

4. The system of claim 1, wherein the body comprises at least one closable gate opening in the bottom part of the top chamber and opening directly onto the outside in order to evacuate the water present in the top chamber toward the outside.

5. The system of claim 1, wherein the module further comprises means for damping the piston during its vertical descent in the top chamber.

6. The system of claim 1, wherein the module further comprises means for damping the lateral guiding of the piston during its displacement in the top chamber.

7. The system of claim 1, wherein the rod of the module opens at an upper end by way of a pressure-balancing valve so as to promote the intake of air and the filling of the compression chamber during the rise of the piston.

8. The system of claim 1, comprising two power-producing modules intended to operate by turns and supplying pressurized water to the same hydroelectric turbine.

9. A method for operating the system for producing hydroelectric power of claim 1, successively comprising for each module:
the closing of the means for evacuating the water present in the top chamber toward the outside;
the opening of the first valve and of the second valve to respectively fill the top chamber and the compression chamber, with water, the filling of the top chamber causing a displacement of the piston toward the top of the cylindrical body; and
once the top chamber has entirely filled with water, the closing of the first valve and of the second valve, followed by the opening of the means for evacuating the water present in the top chamber toward the outside, the draining of the top chamber causing a downward displacement of the piston and of its rod, the downward displacement of the rod exerting a strong pressure on the water contained in the compression chamber which is evacuated through the injection nozzle in order to supply pressurized water to the hydroelectric turbine.
